(19) United States
(12) Patent Application Publication
(10) Pub. No.: US 2002/0032829 A1
(43) Pub. Date: Mar. 14, 2002

(54) Microprocessor memory device controller

(75) Inventor: Monte J. Dalrymple, Livermore, CA (US)

Correspondence Address: John P. O'Banion, O'BANION & RITCHEY LLP, Suite 1550, 400 Capitol Mall, Sacramento, CA, 95814, US

(73) Assignee: Z-WORLD, INC., Davis, CA

(21) Appl. No.: 09/894,838

(22) Filed: Jun. 27, 2001

Related U.S. Application Data
(60) Provisional application No. 60/214,710, filed on Jun. 28, 2000.

(51) Int. Cl. G06F 12/00

(52) U.S. Cl. 711/5

(57) ABSTRACT

A memory manager which is capable of modifying microprocessor memory access signals to selectively control access to memory devices as a series of memory banks. Memory bank control registers are associated with each memory bank for retaining interface parameters utilized by the memory manager to control memory access signal generation for each memory bank. By way of example, the memory bank control register allows the selection of wait states, access signal generation, write protection, and page-mode addressing as a result of selective address signal inversion. The memory manager may be implemented within a microprocessor, or integrated within a separate circuit.

### CROSS-REFERENCE TO RELATED APPLICATIONS

This application claims priority from U.S. provisional application serial number 60/214,710 filed on Jun. 28, 2000, incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright rights whatsoever. The copyright owner does not hereby waive any of its rights to have this patent document maintained in secrecy, including without limitation its rights pursuant to

### BACKGROUND OF THE INVENTION

1. Field of the Invention

The invention pertains generally to microprocessors and related circuits, and more particularly to a memory manager for controlling memory access within a set of memory banks.

2. Description of the Background Art

Microprocessors, and other forms of processing elements, have become the foundation upon which intelligent devices and systems are being designed. The term microprocessor will be utilized herein to refer to a number of similar instruction processing devices, such as microcontrollers, central processing units, microprocessor cores (such as used within ASICs), and digital signal processing devices (DSP chips). These microprocessors often are required to interface with multiple memory devices configured within the address space of the processor. Additional circuitry, often referred to as “glue logic”, is typically required to properly interface a collection of memory devices to a microprocessor. In many cases the memories utilized are of disparate sizes, speeds, and configurations such that interfacing is further complicated. It will be recognized, for example, that slower memory devices, such as FLASH memory, may require the incorporation of one or more wait states during a memory access operation. It will also be appreciated that memory technology changes readily, and that the conventional use of “glue logic” interfaces are often unable to adapt to memory device changes without necessitating circuit changes, or at least the altering of jumper settings or the reprogramming of PLAs.

In addition, address space limitations within many microprocessors constrain the incorporation of ongoing program enhancements. In many cases it would be desirable to extend the addressable range of the processor. Bank switching has been utilized conventionally for extending processor address range, however, the typical ad-hoc discrete implementation of many bank switching circuits does not lend itself to the use of memory devices having various sizes and configurations while they impose constraints on system software design.

Therefore a need exists for a system and method by which memory devices may be readily interfaced to a microprocessor. The present invention satisfies those needs as well as others, and overcomes the deficiencies of previously developed solutions.

### BRIEF SUMMARY OF THE INVENTION

The present invention provides a flexible memory management circuit or device, for use with a microprocessor, or other processing element. The memory management unit may be either integrated as a memory control circuit within a microprocessor, or implemented as one or more memory control modules to be utilized in conjunction with a microprocessor, or other form of processing element. For the sake of simplicity, both forms of memory management unit will be referred to as a memory manager.

The memory manager is configured to modify interface signals between the microprocessor and memory devices within a given portion of the processor address space. The address space controlled by the memory manager is subdivided into a number of “memory banks”. It should be appreciated that a “memory bank” is a logical construct and the interfacing of the memory devices need not directly correspond with the memory banks. The “memory bank” construct provides a flexible mechanism for partitioning memory space wherein the exact composition of memory device sizes and types to be interfaced to the memory manager need not be unduly constrained. The memory manager allows the microprocessor to control aspects of the interface signals between the microprocessor and the memory devices, such that compatible interface signals are output to each memory device within the memory bank. Interface signals are received by the memory manager from the microprocessor, modified according to memory bank settings, and output to a memory device connected at an address within the memory bank. Modification of the interface signals within each bank is controlled by selection values contained within one or more memory bank control registers. Preferably, the selection values are provided as bit settings within the memory bank control register which is accessible by programs executing on the microprocessor. By way of example, the following elements of the interface may be preferably selected within each memory bank:

(1) number of wait states;

(2) write protection for a given bank;

(3) write enable (˜WEx) signal selection per bank;

(4) output enable (˜OEx) signal selection per bank;

(5) chip enable (˜CSx) signal selection per bank; and

(6) inverting of address signals to utilize page mode memory extension.

It will be appreciated that certain applications may not require every preferred feature of the invention, and that the use of functional subsets, or supersets, does not connote a departure from the teachings of the present invention.

By way of example, the described memory management circuit is configured for twenty bit addressing to support a one megabyte (1 MB) address space within four memory bank sections which each span an addressable range of two hundred fifty six kilobytes (256 KB). The exemplified memory devices are depicted as eight bit wide devices, however, it will be appreciated that memories of other widths may be supported for memory management circuits associated with processors having other data bus widths. Up to six memory devices may be directly supported in the illustrated embodiment which outputs three chip select signals, two write enable signals, and two output enable signals. Through utilizing address line inversion, page swapping is performed which multiplies the addressable memory space controlled by the memory manager. The addressable range for the depicted embodiment of the memory manager is extended from 1 MB to a page addressable 6 MB. It will be appreciated that multiple memory controllers may be connected to a single microprocessor to extend the amount of memory space that may be addressed.

An object of the invention is to provide a means for interfacing memory devices to a microprocessor.

Another object of the invention is to provide programmable wait state generation for memory devices on a per memory bank basis.

Another object of the invention is to allow for extending the address space by using programmable address line inversion within the memory manager on a per memory bank basis.

Another object of the invention is to provide for the programmable selection of which interface signals are to be used by memory devices connected at an address associated with a given memory bank.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of a memory control module configured to interface between a microprocessor and one or more memory devices according to an aspect of the present invention.

FIG. 2 is a schematic of a microprocessor containing a memory management unit according to an embodiment of the present invention, shown interfacing to a pair of memory devices.

FIG. 3 is a block diagram of memory devices shown receiving interface signals as supplied by a memory controller according to an aspect of the present invention.

FIG. 4 is a memory map of microprocessor physical address space divided into memory banks according to an aspect of the present invention.

FIG. 5 is a schematic of memory devices, at or below memory bank size, being interfaced with a microprocessor containing a memory controller according to an aspect of the present invention.

FIG. 6 is a schematic of memory devices, larger than memory bank size, being interfaced with a microprocessor containing a memory controller according to an aspect of the present invention.

FIG. 7 is a schematic of memory devices of various sizes being interfaced with a microprocessor containing a memory controller according to an aspect of the present invention.

FIG. 8 is a schematic of numerous memory devices interfaced with a microprocessor containing a memory controller according to an aspect of the present invention, shown with default pages selected within each memory bank.

### DETAILED DESCRIPTION OF THE INVENTION

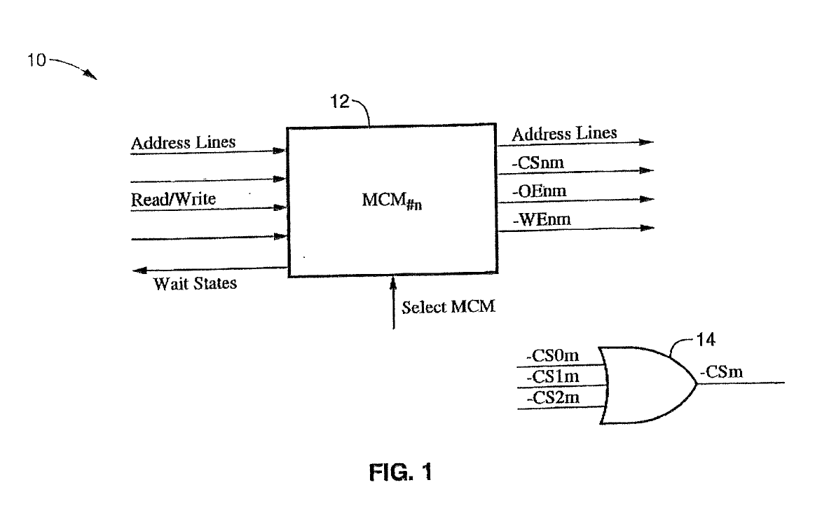

Referring more specifically to the drawings, for illustrative purposes the present invention is embodied in the apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

FIG. 1 illustrates an integrated circuit 10 containing a memory control module 12, and an uncommitted logic gate 14. Memory control module 12 receives a first set of interface signals from a microprocessor and outputs a second set of interface signals to a collection of memory devices. The first set of interface signals may comprise select address signals, enable strobes, and wait state control signals. The interface signals output by memory control module 12 are generated according to programmed settings of the associated memory bank within whose address space the memory device is located. This second set of interface signals output by memory control module 12 may comprise multiple chip selects, multiple write enables, multiple output enables, and selected address lines. Memory control module 12 is activated upon microprocessor activation of a module select line. It should be appreciated that the memory control module is preferably configured with input lines for selecting an I/O address range for the device to allow addressing a number of modules within the I/O address space of the microprocessor. The uncommitted multi-input OR-gate device 14 may be utilized, at the discretion of the system designer, for combining chip select signals for use with larger memory devices.

The memory device is shown as a separate integrated circuit which preferably contains at least one uncommitted logic device, such as an OR-gate, or other forms of uncommitted combinatorial and/or sequential logic suitable for a variety of applications. One or more of these memory control modules may be interfaced with a single microprocessor to extend the number of memory devices supported. Multiple memory control modules may be utilized with a single microprocessor by splitting up the memory address space of the microprocessor into zones which are each associated with a particular memory control module. As the microprocessor generates an address that falls within the boundary of a given zone, the memory controller module for that zone is selected, and the memory bank registers of the memory control module are activated to modify the access signals being generated. It will further be appreciated that a given microcontroller may contain multiple memory control modules. The memory control circuit may also be referred to as a memory manager, or memory management unit (MMU). Memory control modules may be interfaced to a conventional processing element or to a processing element according to the present invention having one or more integrated memory control circuits.

The memory manager supports the use of banked memory and allows accessing a mixture of memory types and sizes. The memory manager accommodates a mixture of memory devices by modifying interface signals being output to the memory devices as necessary. Preferably the memory manager outputs multiple sets of interface signals, such as chip selects, output enables, and write enables for use within each of its memory banks. The selection of which set of signals are to be generated for a particular bank of memory is determined by a setting within the associated memory bank control register. In addition, the parameters for other access signals are controlled by the memory control module according to memory bank register settings. The number of memory banks to be defined within a particular memory control module implementation are preferably determined by considering both the number and nature of memory devices to be utilized with the range of applications to be addressed. The exemplified embodiment divides a one megabyte memory address space into four memory banks (MB0-MB3). Table 1 lists the selection of memory bank selection registers (MB0CR-MB3CR) in response to the state of upper address bits A18 and A19. It will be appreciated that the number of memory banks and the address range over which the memory control module operates may be designed with any desired capacity without departing from the present invention. Table 2 lists the address of each memory bank register within the I/O address space, in addition to its default setting, in response to a memory manager reset. As shown in the table, a reset causes MB0CR to be initialized to binary 00h which clears any bit inversion and selects the generation of ˜CS0, ˜OE0, and ˜WR0 within that bank. The ‘x’ in the memory banks other than MBOCR indicate that the operation of the microprocessor is not affected by the setting of these ‘x’ bits when coming out of a reset state. These ‘x’ bits are referred to as “don't care” bits because their state is unknown and inconsequential. It will be appreciated that during the boot-up process the hardware and all memory banks should be properly initialized. It should also be appreciated that the resetting of MB0CR causes it to default to a state of all zeros after reset which selects a maximum value for wait state generation to allow the processor to boot up under default conditions into even the slowest allowable memory.

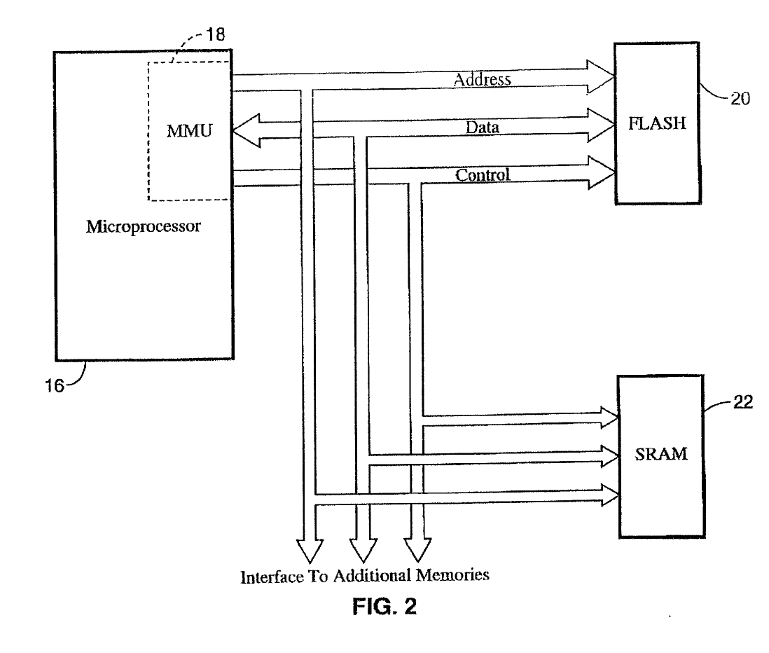

FIG. 2 illustrates a microprocessor 16 having an integral memory management unit 18, according to the present invention, which interfaces to a FLASH memory device 20 and an SRAM memory device 22. Buses are shown with address lines, data lines, and access control lines interconnecting memory devices and the microprocessor.

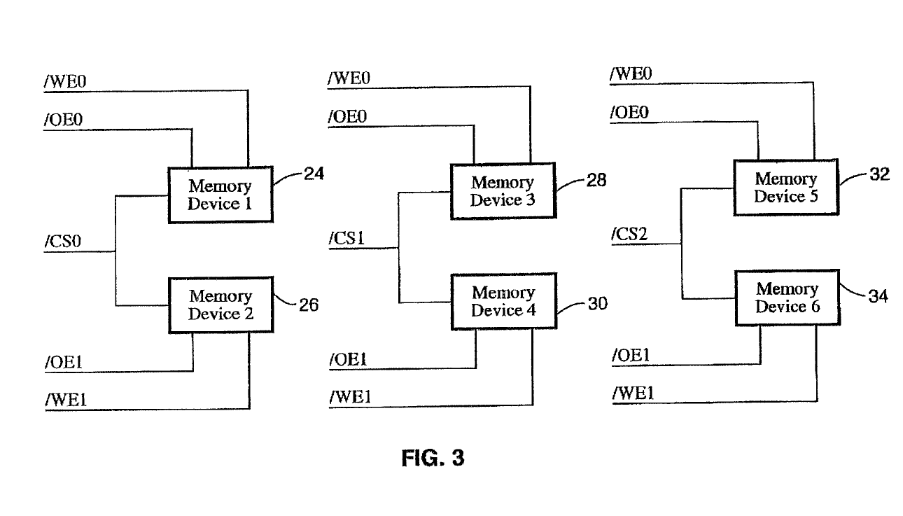

FIG. 3 exemplifies six memory devices 24, 26, 28, 30, 32, and 34 which receive interface signals, such as from an embodiment of the present memory manager, without the addition of glue logic. Although direct support of up to six memory devices per memory manager should be adequate for the majority of applications, it should however, be appreciated that the memory manager may be extended to directly support any desired number of memory devices. Depicted in the figure are connections between chip select lines (˜CS0, ˜CS1, ˜CS2) to three pairs of memory devices. Distinguishing which memory device within the pair is being accessed is determined by which enable signals are utilized. The example illustrates upper memory devices 24, 28, 32 being accessed utilizing write enable zero (˜WE0) for write access, and output enable zero (˜OE0) for read access, while the lower memory devices 26, 30, 34 are accessed by means of write enable one (˜WE1) and output enable one (˜OE1). The memory devices are essentially multiplexed onto the chip select lines and distinguished by the access enable strobes. It should be appreciated that the present invention may be implemented utilizing a number of different memory selection configurations that provide more or less signal multiplexing without departing from the invention. Furthermore, it should be appreciated that the present memory device interface can accommodate a given number of memory devices using a reduced number of signal lines.

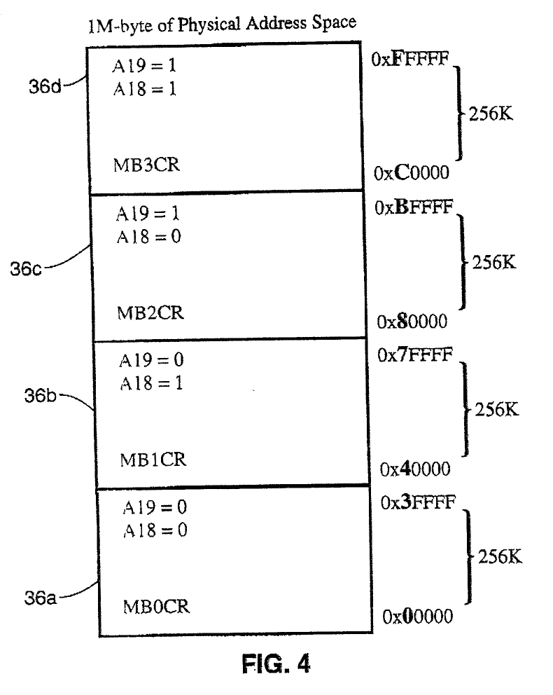

FIG. 4 is a memory map of memory banks 36a-36d within a 1 MB portion of the physical address space of a microprocessor according to an aspect of the present invention, with each of the four memory banks spanning 256 KB. A label associated with each memory bank control register (MB×CR—Memory Bank ‘x’ Control Register) is shown along with the upper address bit settings which correspond to the selection of that particular memory bank.

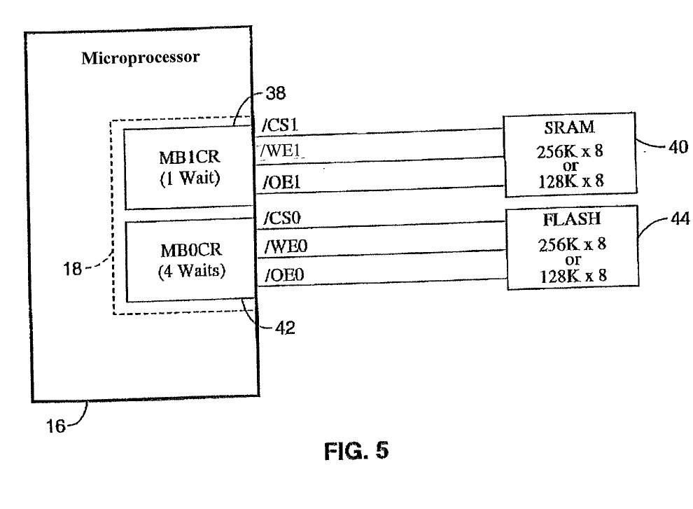

FIG. 5 depicts the connection of a pair of memory devices to the memory management unit 18 of microprocessor 16. The memory bank control register one 38, controls static RAM memory 40, while memory bank control register zero 42 controls FLASH (non-volatile electrically reprogrammable ROM) memory device 44. Under memory bank control register settings the interface signals generated by memory bank one and memory bank zero provide one wait state when accessing the static memory device 40 and four wait states when accessing the slower non-volatile FLASH memory device 44. Table 3 describes the use of bits six and seven within each memory bank control register for setting the wait interval at zero, one, two, or four wait states. Preferably, the wait state generator circuit within the memory manager is configured to generate an additional wait state during write operations as write operations often require additional setup time. It will be appreciated that wait states are clock intervals added to a standard write or read access which extend the timing to be compatible with the memory device. The number of clock cycles spanned by a standard write or read of a microprocessor is highly dependent on the implementation of the particular microprocessor.

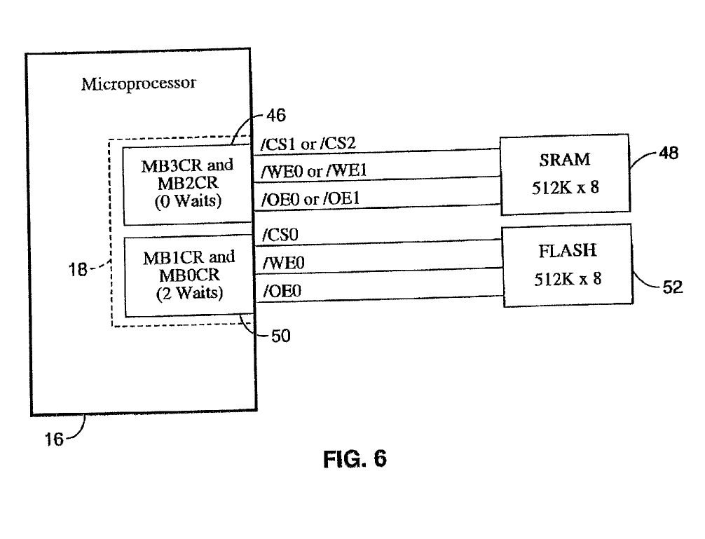

FIG. 6 illustrates the connection of a pair of memory devices to the memory manager 18 within microprocessor 16. The interface signals to be output for each memory bank may be selected in the memory bank control register. It will be appreciated that the memory devices depicted in the figure exceed the memory bank size of 256 KB. A pair of memory bank select registers 46 comprising MB2CR and MB3CR interface a 512 KB SRAM memory 48, and are configured to generate ˜CSI or ˜CS2, write enable signals ˜WE0 or ˜WE1, and output enable signals ˜OE0 or ˜OE1. A pair of memory bank select registers 50 comprising MBOCR and MBICR interface a 512 KB FLASH memory device 52, and are configured to generate ˜CS0, ˜WE0, and ˜OE0. A wait state value of two has been set on the lower two memory banks for FLASH memory device 52, while a wait state value of one has been set in the upper memory bank registers to control the faster SRAM memory device 48. It will be appreciated that memory devices 48, 52, each span two memory banks and that each memory bank controls access to a portion of the associated device address space. Referring to the memory bank control register bit functions listed within Table 3, it can be seen that this embodiment of the invention utilizes the lower two binary bits of the register to specify chip select use, specifically: 00b=˜CS0; 01b=˜CS1; and 1×b=˜CS2. The control register table also lists the selection of enable signal generation as being controlled by two bits, specifically: 00b=˜OE0+˜WE0; 01b=˜OE1+˜WEI; 10b=˜OE0 only (write protect); 11b=˜OE1 only (write protect). The “write protect” setting modes inhibit the generation of write enable pulses to the associated memory bank to prevent inadvertent write operations from being attempted as a result of spurious program execution. Write protection can be beneficial in many systems, such as when performing read accesses from a FLASH memory device, because although the device is protected from inadvertent writing by lock codes any inadvertent write attempt could lead to a system crash.

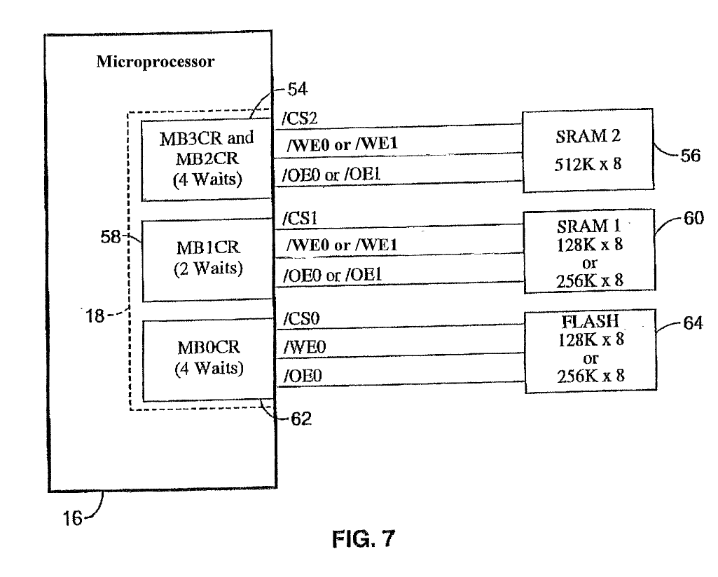

FIG. 7 illustrates the connection of three memory devices of various sizes and configurations to memory manager 18 of microprocessor 16. The second and third memory bank registers (MB2CR, MB3CR) 54 are set to generate four wait states for the 512 KB SRAM memory 56. Memory bank register one (MBICR) 58 is set to generate two wait states for SRAM memory 60 having a size of up to 256 KB. Memory bank register zero (MB0CR) 62 is set to generate four wait states for FLASH memory 64 having a size of up to 256 KB. It will be appreciated from the foregoing examples that the described implementation of the memory management unit may be utilized for supporting a number of memory topologies without the need of additional logic circuitry.

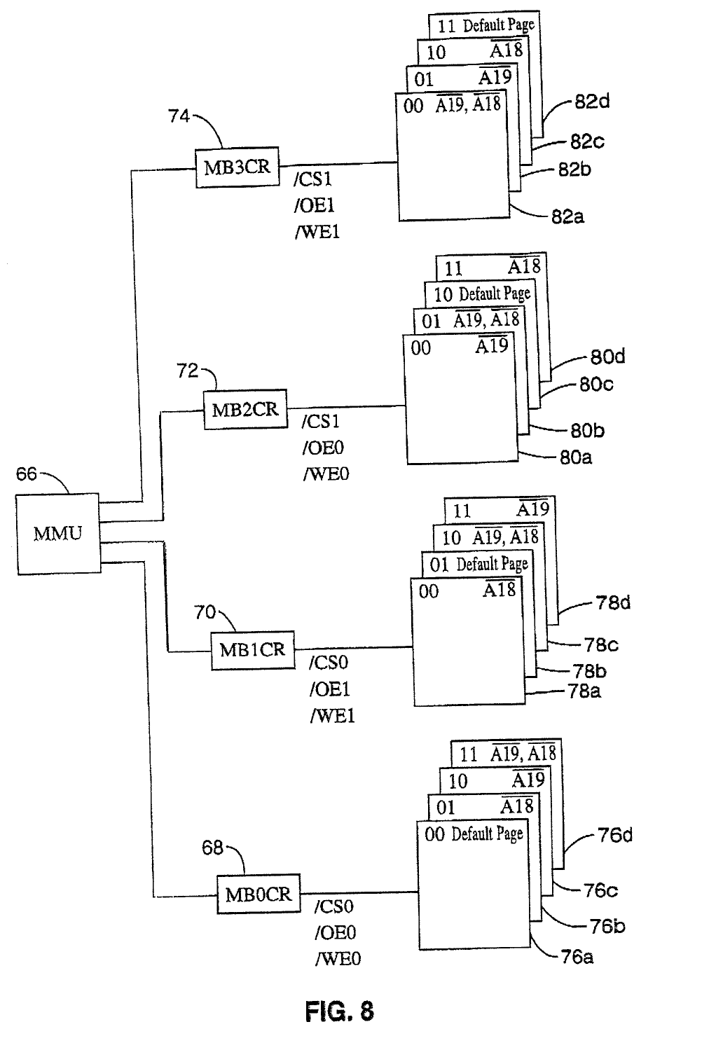

FIG. 8 illustrates interfacing four memory devices to memory management unit 66, wherein the size of each memory device exceeds the address space of a memory bank. Each of the four memories is exemplified as a 1 MB memory within the present embodiment and is utilized as a collection of four memory pages. Although memory banks 68, 70, 72, 74, of memory manager 66 within this embodiment are capable of 11 addressing up to only 1 MB of memory address space, they are configured with address line inversion selection bits for addressing a larger address space by utilizing memory page swapping. A memory device at the lower portion of the address space is shown comprising pages 76a-76d, while the additional three memory devices are similarly configured. Following a memory manager reset, the memory banks are configured to pass address lines (A18, A19) from the microprocessor through to the memory devices without inversion whereby default pages are selected within each memory device. Default pages comprise the first page 76a of the memory device addressed by MB0CR, the second page 78b of the memory device addressed by MBICR, the third page 80c of the memory device addressed by MB2CR, and the fourth page 82d of the memory device addressed by MB3CR. Referring to Table 3, two bits of the memory bank control register are utilized for inverting address lines, which in this case translate to address lines A18, A19. It will be appreciated that the memory space of the memory manager may be divided into more pages by providing for the inversion of additional address lines. As an example of using address line inversion, consider the inversion of address line A18 within memory bank zero (MB0CR) 68. The memory device having pages 76a through 76d is accessed for any read operation performed between hexadecimal address 000000h and 03FFFFh. Following a device reset memory accesses are performed to the default memory page 76a interfaced to MBOCR. Upon inverting address A18, to redirect the address line output of the memory manager, all accesses to hexadecimal address 000000h and 03FFFFh are redirected by outputting an inverted A18 driven to the device to access the second memory page 76b. Access may be similarly gained to each of the pages within an oversized memory device. Although four memory devices have been shown utilizing page mode addressing within each memory bank, it should be appreciated that page addressing may be used with individual memory devices. The memory access interface of the present invention is capable of providing support for memory extension through page swapping. The technique of swapping pages within a memory bank may be implemented in a number of ways for encompassing any desired topology and number of pages per memory device.

Accordingly, it will be seen that this invention provides a memory manager for interfacing one or any plurality of memory devices to a microprocessor. The teachings of the present invention may be applied to memory interfacing irrespective of data path width, address space, or number of memory devices. Furthermore, the memory manager may be incorporated within the microprocessor, or manufactured as a separate device for connection to a microprocessor. Single or multiple levels of memory management according to the invention may be incorporated within a given microprocessor or external memory management unit. The circuits and descriptions herein are provided to exemplify the teachings of the present invention, however, one of ordinary skill can readily modify the implementation examples without departing from the present invention.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Memory Address to Control Register Mapping

| A[19:18] | Control Register used |
|---|---|
| 00 | MB0CR |
| 01 | MB1CR |
| 10 | MB2CR |
| 11 | MB3CR |

TABLE 2
Memory Bank Reset Values

| Register Name | Mnemonic | I/O address | R/W | Reset |
|---|---|---|---|---|
| Memory Bank 0 Control | MB0CR | 00010100b | W | 00000000 |
| Register | | | | |
| Memory Bank 1 Control | MB1CR | 00010101b | W | xxxxxxxx |
| Register | | | | |
| Memory Bank 2 Control | MB2CR | 00010110b | W | xxxxxxxx |
| Register | | | | |
| Memory Bank 3 Control | MB3CR | 00010111b | W | xxxxxxxx |
| Register | | | | |

TABLE 3
Bit Functions within a Memory Bank Control Register

| Bit(s) | Value | Description |
|---|---|---|
| 7:6 | 00 | Four (five for writes) wait states inserted for this bank |
| | 01 | Two (three for writes) wait states inserted for this bank |
| | 10 | One (two for writes) wait states inserted for this bank |
| | 11 | Zero (one for writes) wait states inserted for this bank |
| 5 | 0 | Pass A[19] for this bank |
| | 1 | Invert A[19] for this bank (support page swapping) |
| 4 | 0 | Pass A[18] for this bank |
| | 1 | Invert A[18] for this bank (support page swapping) |
| 3:2 | 00 | /OE0 and /WE0 are active for this bank |
| | 01 | /OE1 and /WE1 are active for this bank |
| | 10 | /OE0 only (write protect mode) |
| | 11 | /OE1 only (write protect mode) |
| 1:0 | 00 | /CS0 is generated for this bank |
| | 01 | /CS1 is generated for this bank |
| | 1x | /CS2 is generated for this bank |

What is claimed is:

1. An apparatus for interfacing memory devices to an associated microprocessor having a predetermined address space, comprising:
(a) a memory manager circuit configured for receiving selected access control signals from said microprocessor;
(b) said memory manager circuit configured with one or more memory banks across which a portion of said address space is distributed; and
(c) means for generating memory device interface signals which are responsive to interface settings for each memory bank which are established under program control.

2. An apparatus as recited in claim 1, wherein the memory manager circuit is integrated within the circuitry of said microprocessor.

3. An apparatus as recited in claim 1, wherein the memory manager circuit is configured within a device that is separate from said microprocessor.

4. An apparatus as recited in claim 1, wherein the memory manager circuit is configured to generate memory device interface signals for at least four memory banks.

5. An apparatus as recited in claim 1, wherein at least one memory bank control register is associated with each memory bank and contains fields for controlling the generation of memory device interface signals within the given memory bank.

6. An apparatus as recited in claim 1, wherein the memory device interface signal generation means comprises a wait state generator configured to generate a selected number of wait states during memory access within a given memory bank in response to a wait state setting that is responsive to program control.

7. An apparatus as recited in claim 1, wherein the memory device interface signal generation means comprises inversion circuitry configured to invert selected address signals in response to an inversion setting for the memory bank that is responsive to program control.

8. An apparatus as recited in claim 1, wherein the memory device interface signal generation means comprises circuitry which can block write enable generation under program control for an associated memory bank.

9. An apparatus as recited in claim 1, wherein the memory device interface signal generation means comprises circuitry configured to output a given write enable signal, as selected from multiple write enable outputs, in response to a write enable selection setting for the memory bank which is responsive to program control.

10. An apparatus as recited in claim 1, wherein the memory device interface signal generation means comprises circuitry configured to output a given output enable signal, as selected from multiple output enable outputs, in response to an output enable selection setting for the memory bank which is responsive to program control.

11. An apparatus as recited in claim 1, wherein the memory device interface signal generation means comprises circuitry configured to output a given chip select signal, as selected from multiple chip select outputs, in response to a chip select selection setting for the memory bank which is responsive to program control.

12. In a microprocessor having a central processing unit and which is configured with circuitry to interface with external memory devices within a predetermined memory address space, wherein the improvement comprises:
(a) a memory device controller configured to generate memory device interface signals in response to memory access requests by the microprocessor which are directed at a first address space;
(b) said memory device controller configured with multiple memory banks across which said first address space is distributed; and
(c) said memory device controller generating said memory device interface signals in response to memory bank control register settings established under program control.

13. The improvement recited in claim 12, wherein said memory device controller is configured to generate interface signals for at least four memory banks.

14. The improvement recited in claim 12, wherein the memory device controller is configured to generate memory device interface signals that may include wait states generated in response to microprocessor memory access requests within selected memory banks.

15. The improvement recited in claim 14, wherein the memory device controller is configured to generate a given number of wait states in response to a value contained within a memory bank control register that is under program control.

16. The improvement recited in claim 12, wherein the memory device controller is configured to prevent the generation of write enable signals for a given memory bank according to a write protection setting contained within the memory bank control register.

17. The improvement recited in claim 12, wherein the memory device controller is configured to generate interface signals comprising a write enable signal, as selected from multiple write enable outputs, when executing access requests within a given memory bank in response to associated control register settings.

18. The improvement recited in claim 17, wherein either of two write enable outputs may be selected.

19. The improvement recited in claim 16, wherein the memory device controller is configured to generate interface signals comprising an output enable signal, as selected from multiple output enable outputs, when executing access requests within a given memory bank in response to associated control register settings.

20. The improvement recited in claim 20, wherein either of two output enable outputs may be selected.

21. The improvement recited in claim 12, wherein the memory device controller is configured to generate a chip select signal, as selected from multiple chip select signals in response to memory bank control register settings.

22. The improvement recited in claim 12, wherein the memory device controller is configured to invert memory interface signals when executing access requests within a given memory bank in response to associated control register inversion settings.

23. The improvement recited in claim 22, wherein the memory device controller is configured to invert address signals to swap pages within a given memory device whose size in bytes exceeds the direct address range of the selected bank.

24. A microprocessor configured for accessing external memory devices within a predetermined memory address space, comprising:
(a) a memory device controller configured to interface to at least one memory device within a portion of said memory address space that spans a memory bank;
(b) said memory device controller configured with memory bank control registers for retaining memory interface parameters; and
(c) a wait state generator responsive to settings within said memory bank control register and capable of generating a selected number of wait states during memory accesses within the associated memory bank according to a wait state value set within said memory bank control register.

25. A microprocessor as recited in claim 24, wherein one, two, or four wait states may be generated by said wait state generator in accord with the value set within said memory bank control register.

26. A microprocessor as recited in claim 24, further comprising a write protect circuit capable of blocking the generation of write enable signals to a given memory bank according to write protect settings within the memory bank control register which may be set under program control.

27. A microprocessor as recited in claim 24, further comprising a write enable signal generator configured to generate a particular write enable signal selected under program control for the given memory bank from multiple write enable signals.

28. A microprocessor as recited in claim 27, wherein two write enable outputs are available for selection within a memory bank control register.

29. A microprocessor as recited in claim 24, further comprising an output enable signal generator configured to generate a particular output enable signal selected under program control for the given memory bank from multiple output enable signals.

30. A microprocessor as recited in claim 29, wherein two output enable outputs are available for selection within a memory bank control register.

31. A microprocessor as recited in claim 24, further comprising a chip select signal generator configured to generate a particular chip select signal selected under program control from multiple memory chip select outputs.

32. A microprocessor as recited in claim 31, wherein two chip select outputs are available for selection within a memory bank control register.

33. A microprocessor as recited in claim 24, wherein the memory device controller is configured to invert selected address signals being output for connection to memory devices within a given bank of memory.

34. A microprocessor as recited in claim 33, wherein the selection of which address lines are to be inverted when accessing a given memory bank is determined by the memory device controller in response to settings within the associated memory bank control register.

35. A microprocessor as recited in claim 34, wherein memory bank controller is configured to invert the address lines being output to a given memory device whose size in bytes exceeds the direct address range of the selected bank, such that pages of memory within the device are capable of being swapped to extend the memory range accessible by the memory bank controller.

36. A microprocessor configured for accessing external memory devices within a given memory address space, comprising:
(a) a memory device controller configured to divide at least a portion of said memory address space into memory banks;
(b) said memory device controller configured with bank selection registers for retaining memory interface parameters for each memory bank; and
(c) said memory device controller configured to output memory device interface signals for a given memory bank which are responsive to the settings within the associated memory bank control register.

37. A microprocessor as recited in claim 36, wherein the interface signals comprise address signals and access enable signals configured for receipt by memory devices.

38. A microprocessor as recited in claim 37, wherein the memory device controller is configured for selective inversion of selected address signals.

39. A microprocessor as recited in claim 37, wherein the selective inversion of address signals is responsive to the setting within the memory bank control register.

40. A microprocessor as recited in claim 37, wherein multiple sets of access enable outputs are generated by the memory device controller, and the selection of which set of access enable outputs to generate is determined by a selection setting contained within the memory bank control register whose value may be set under program control.

41. A microprocessor as recited in claim 40, wherein the multiple access enable signals comprise write enable signals configured for receipt by memory devices to clock memory writes therein.

42. A microprocessor as recited in claim 40, wherein the multiple access enable signals comprise output enable signals configured for receipt by memory devices to clock memory reads therein.

43. A microprocessor as recited in claim 40, further comprising a wait state generator that responds to the value set within said bank selection register by generating a selected number of wait states during memory accesses when accessing the associated memory bank.

44. A microprocessor configured for accessing external memory devices within a first memory address space, comprising:
(a) a memory device controller configured to interface to at least one memory device spanning portions of said first memory address space as memory banks;
(b) said memory device controller configured with bank selection registers for storing memory interface parameters; and
(c) said memory controller configured to invert address signals when accessing memory devices within a selected memory bank in response to the value retained within the memory bank control register, wherein memory pages may be swapped within the memory device to extend the amount of addressable memory within a given memory bank.

45. A microprocessor as recited in claim 44, further comprising a wait state generator capable of generating a number of wait states for the memory bank in response to a value set within an associated said bank control register.

46. A method of controlling access to memory devices interfaced to a microprocessor having a predetermined memory address range, comprising:
setting memory access parameters within a memory bank control register associated with a bank of memory that spans a portion of said memory address range; and
generating memory access signals to the memory devices in response to the settings within the memory bank control register.

47. A method as recited in claim 46, wherein generating memory access signals comprises inserting wait states when accessing a memory device within a given memory bank in response to a wait state value being set within the memory access parameters of the given memory bank control register.

48. A method as recited in claim 46, wherein generating memory access signals comprises generating one set of memory interface signals selected from multiple sets of memory interface outputs, wherein the selection is determined for a given memory bank by memory access parameters retained within the associated memory bank control register.

49. A method as recited in claim 48, wherein the memory access signal comprises write enable signals, output enable signals, and chip select signals.

50. A method as recited in claim 46, wherein the generation of memory access signals is subject to the blocking of write signals in response to a write protection value that may be set within the memory access parameters of the given memory bank control register.

51. A method as recited in claim 46, wherein inverting of address lines within the generated memory access signals may be performed in response to the setting of the associated memory bank control register so that page swapping within a given memory device may be used to extend the addressable memory range within the given memory bank.
